(19) United States
(12) Patent Application Publication
(10) Pub. No.: US 2003/0219061 A1
(43) Pub. Date: Nov. 27, 2003

(54) Liquid vessel with time approximation

(76) Inventor: Mark E. Seeger, Troy, NY (US)

Correspondence Address: HOFFMAN WARNICK & D'ALESSANDRO, LLC, 3 E-COMM SQUARE, ALBANY, NY, 12207

(21) Appl. No.: 10/154,350

(22) Filed: May 23, 2002

(51) Int. Cl. G01K 1/14; G01K 13/00

(52) U.S. Cl. 374/152; 374/150; 374/157

(57) ABSTRACT

A liquid vessel capable of sensing the temperature of its liquid contents and outputting a time based on the temperature. The time can be, for example, an estimate of the time that remains before the contents reach a specified temperature range and/or an estimate of the time that remains while the liquid is within the specified temperature range.

### BACKGROUND OF THE INVENTION

1. Technical Field

This invention relates to a liquid vessel including means of indicating a condition of the contents. More particularly, the invention provides a liquid vessel for communicating a time based on a temperature of a liquid contained in the vessel.

2. Background Art

The majority of adults in many countries enjoy hot beverages such as coffee or tea. This custom has comprised a quotidian aspect to many cultures for centuries. Hot chocolate flavored milk is another example of a popular hot beverage which is typically sipped from a cup or mug while quite hot. Similarly, many people of different countries enjoy cold beverages such as various carbonated and non-carbonated beverages, and water.

The term ‘hot’ as opposed to ‘cold’ is a relative comparison but serves to characterize the difference between two gross categories of liquids. The preparation of either tea or coffee primarily involves brewing which requires a boiling temperature. Hence, a ‘hot beverage’ such as tea or coffee often possesses a temperature which is below, yet proximate, the temperature of boiling water. For example, the presence of steam, though wholly dependent upon atmospheric conditions, provides an indication that a given beverage in an open container is hot. This defines ‘hot’ as hereinafter employed in association with the word ‘beverage’. Similarly, a ‘cold’ drink or beverage is typically above, but proximate, the freezing point of water, particularly if ice is used in preparation or serving. The presence of ice in a beverage provides an assurance that a drink is cold, as understood herein. In general, hot beverages are those beverages that are more enjoyable when at a temperature above room temperature, while cold beverages are those beverages that are more enjoyable when at a temperature below room temperature.

Many individuals have a strong personal preference for hot beverages, such as tea or coffee, and for cold beverages such as lemonade or carbonated beverages. With the case of hot beverages, the beverage is rarely served at one's preferred temperature because it starts out too hot. Furthermore, many different individuals have diverse preferred drinking temperature ranges for the hot beverages they drink. While some may prefer their hot beverage very near the boiling temperature of water, say 90 degrees Celsius, others may desire a drinking temperature that is about half that, say 45 degrees Celsius. Regardless of their specific preferred drinking temperature, or temperature range, this creates the necessity for one's hot beverage to cool before one can begin drinking it. This cooling time is primarily dependent on the initial serving temperature of the beverage, the insulation properties of the drinking vessel and the ambient temperature conditions of the drinking vessel's surroundings. Similar dependent properties play a role for cold beverages as well. Many individuals have a strong personal preference for cold beverages, such as carbonated sodas and lemonades. Typically, cold beverages are served within the preferred temperature range and become undesirable as they warm to the ambient temperature. Once served cold, the beverage temperature will remain in the preferred cold temperature range for only a certain amount of time before the beverage warms to the ambient temperature and is no longer preferred. Similarly, a hot beverage will require a certain amount of time to cool to the desired drinking temperature or temperature range. Once at the preferred drinking temperature, or once within the preferred drinking temperature range, the hot beverage will remain there for only a certain amount of time before it further cools and becomes undesirable.

If the preference is for a beverage hot enough to visibly steam under typical conditions, the beverage imbibed may be hot enough to be scalding, a condition that is dangerous, as testified at times in the United States of America during successful litigation against the purveyor of a scalding hot cup of coffee. Moreover, many people have a preference for a particular temperature range or approximate temperature which is below or proximate the threshold of steaming under typical conditions. In either case, the presence of visible steam is not considered a reliable means of determining the temperature of a hot beverage.

Therefore, it is considered that many people who enjoy hot beverages of a particular temperature or temperature range, would benefit from a drinking vessel that accurately indicates the amount of time that remains before the beverage reaches an individual's preferred drinking temperature or temperature range, as well as indicate how much time remains for the beverage to remain at one's preferred drinking temperature or for the beverage to remain in one's preferred drinking temperature range. Additionally, it is considered that many people who enjoy cold beverages that are at or below a particular temperature threshold would benefit from a drinking vessel which accurately indicates the amount of time that remains before the beverage becomes too warm to drink.

Many bottles intended for the feeding of infants possess means of indicating the temperature of the contents, indeed, an entire subclass of the U.S. patent classification system is devoted to the subject. Examples of these are the following: A mug utilizing an LED display is U.S. Pat. No. 4,878,588 issued to Ephraim Nov. 7, 1989 for a ‘Baby Nursing Bottle with Temperature Indicator’, another example is U.S. Pat. No. 3,125,984 issued to Okuyama Mar. 24, 1964 for a ‘Feeding Bottle Capable of Indicating Temperature of Therein Contained Milk for the Unweaned Child.’ Many of these patents disclose quite accurate temperature indications, particularly for determining normal body temperature, 37 degrees Celsius.

However, only four instances are known in the prior art of open mouth drinking vessels possessing means of indicating the relative temperature of the contents: U.S. Pat. No. 3,135,118 issued to Zlobin Jun. 2, 1964 for a ‘Thermo Cup’; U.S. Pat. No. 3,782,195 issued to Meek et al. Jan. 1, 1974 for a ‘Temperature Indicating Vessel’; U.S. Pat. No. 4,555,040 issued to Butenschon Nov. 26, 1985 for a ‘Glass with Stem, Particularly a Wine Glass’; and U.S. Pat. No. 5,678,925 a issued to Garmaise et al. Oct. 21, 1997 for a ‘Temperature Sensing and Indicating Beverage Mug’.

Zlobin discloses a mug with an internal cavity containing a fluid, such as alcohol, which expands upon heating and causes a whistle and/or a fluid contained in the handle to change color. Meek et al. discloses an open vessel possessing an internal cavity filled with a fluid having a known freezing point which changes state upon filling of the vessel with fluid and indicates the temperature of this fluid relative to the freezing point of the contained fluid, e.g. “COLD”. Butenschon discloses a goblet possessing an inverted thermometer in the stem, its bulb proximate the bowl of the goblet. The temperature range of the thermometer is in accordance with that preferred of wine: from chilled to room temperature. Garmaise discloses an open mouth drinking vessel that senses the temperature of its liquid contents and generates an aural and/or visual indication of the temperature sensed using electronic means.

Diverse devices, other than beverage drinking vessels, utilizing temperature indicating means for an associated fluid are known as well. U.S. Pat. No. 856,768 issued to Comins Jun. 11, 1907 describes a spoon with an integral thermometer intended for yielding the temperature of a mixture being mixed with the spoon. U.S. Pat. No. 4,408,905 issued to Ehrenkranz Oct. 11, 1983 for a ‘Urinary Temperature Measurement Device’ discloses a “funnel shaped receptacle” possessing “liquid crystal measurement means” which also “display [the] temperature registration”. U.S. Pat. No. 4,509,868 issued to Raconi et al. Apr. 9, 1985 for a ‘Temperature Indicating Device for a Cooking Pot and Device-Pot Combination’ discloses a covered cooking pot possessing a crystal diode temperature display integral to the lid. U.S. Pat. No. 5,320,137 issued to Huang Jun. 14, 1994 discloses a ‘Faucet with Liquid Crystal Temperature Indicator’ operating in association with a temperature probe in physical contact with the fluid stream.

Despite the wide variety of drinking vessels and other diverse devices possessing means of indicating the temperature of an associated fluid, as represented in the above discussion, only two open mouth drinking vessels intended for a hot beverage are known. The means of indicating the relative temperature of the beverage held relies upon the principle that fluid, gas or liquid, expands with temperature. This yields a crude indication of the temperature, as in the case of a whistle or color change, and fluid trapped in an internal cavity is generally considered problematic in construction of a mug or cup. Although a thermometer yields an accurate indication of temperature, it is not considered desirable to raise a mug full of hot tea or coffee to eye level to read a thermometer incorporated therein, as it might with a wine goblet.

The means of having a comprehensible temperature indication, as with the previously referenced ‘Temperature Sensing and Indicating Beverage Mug’, U.S. Pat. No. 5,678,925, issued to Gaimaise et al. Oct. 21, 1997, is still not preferred, because it also yields a crude and indirect indication of the beverage contents with respect to the user's preference. If the temperature of a hot or cold beverage is not at this exact value, the fact that the beverage is not at one's exact preferred temperature is all which can be ascertained.

Furthermore, not one of the previously discussed patents indicate what is considered to be a clear and definable need predominate over simply a temperature measurement: How much time remains before one's hot beverage is drinkable, and how much time remains before one's hot and/or cold beverage is no longer desirable. All of the previously discussed patents leave the job of time approximation to the user. Based upon the crude temperature representations of the mug contents, the previous inventions intend the user to use the real time temperature information to approximate how much time remains before their beverage is ready to drink, or how much time remains before their hot beverage is no longer desirable as is the case with a hot beverage already at one's preferred drinking temperature or within one's preferred drinking temperature range, and as with a cold beverage already served at one's preferred temperature or served within one's preferred temperature range.

Within the prior art, one must somehow generate an on-the-spot correlation between the current temperature of the beverage being approximated and the amount of time that may remain before the temperature has reached some value or some range of values deemed the ‘preferred drinking temperature’ or the ‘preferred drinking temperature range.’ This correlation must also take into account such factors as the ambient temperature conditions, the initial serving temperature, the amount of beverage served with respect to the available containment capacity of the drinking vessel and perhaps some other factors.

It is therefore considered that a need exists for a liquid vessel to indicate the amount of time remaining before a hot liquid has cooled to a desired temperature range, and to indicate the amount of time remaining that a hot or cold liquid will remain at a particular temperature range, where the temperature range may be unique to each user. It is further considered desirable to have such an indication be comprehensible from a distance and without any particular orientation required with respect to one's eye level.

### SUMMARY OF THE INVENTION

The current invention provides a liquid vessel that accurately senses the temperature of fluid therein, and further provides an accurate indication of the time remaining until the fluid temperature reaches a user-specified temperature range. Furthermore, the invention can provide the amount of time remaining before the fluid temperature is out of the temperature range.

A further aspect of the present invention is a liquid vessel possessing the capability of accurately sensing the temperature of the liquid held, further providing an accurate indication of the time remaining until the liquid temperature reaches a specified temperature range or falls out of or rises to within a specified temperature range in visual form. Another ancillary object of the present invention is a liquid vessel possessing the capability of accurately sensing the temperature of the liquid held, further providing an accurate indication of the time remaining when the liquid temperature reaches a specified temperature range or falls out of or rises to within a specified temperature range in an aural form. An auxiliary object of the present invention is a liquid vessel possessing the capability of accurately sensing the temperature of the liquid held, further providing an accurate indication of the time remaining until the fluid temperature reaches a specified temperature range or falls out of or rises within a specified temperature range expressed in seconds, minutes, hours, or other unit of time.

Other particular objects of the present invention include yielding accurate aural indication of the time with an annunciator including generation of a simulated human voice, modulation of the aural signal generated by the annunciator dependent upon a sensed temperature in relation to a predetermined time varying the presence, volume, frequency and tone of the aural signal produced by the annunciator in accordance with the time remaining when the fluid temperature reaches a specified temperature range or falls out of or rises to within a specified temperature range based upon the temperature sensed.

Further particular objects of the present invention include yielding accurate visual indication of the time remaining when the fluid temperature reaches a specified temperature range or falls out of or rises to within a specified temperature range, particularly with light emitting diodes (LED) and/or liquid crystal display (LCD) graphic displays with or without backlighting. Still further objects of the present invention concern automatic and manual switching of the power supplied to the various electronic components utilized in the vessel and pressure applied to input controls, i.e. buttons, for the input of user specifications, i.e. preferred temperature range.

Further objects of and benefits deriving from the present invention may become apparent with an understanding of the principles relating to the present invention summarized below applied to achievement of the above stated objects.

In accordance with the present invention, a liquid vessel is provided that provides an accurate indication of the time remaining when the fluid temperature reaches a specified temperature range or falls out of or rises to within a specified temperature range, for the purpose of user convenience and/or improved liquid enjoyment.

A first aspect of the invention provides a liquid vessel, comprising: a hollow interior for holding liquid; a temperature sensing device for sensing a temperature of the liquid; and an output device for communicating a time to a user based on the temperature.

A second aspect of the invention provides a liquid vessel, comprising: a hollow interior for holding liquid; a temperature sensing device for sensing a temperature of the liquid; an output device for communicating a time based on the temperature to a user; a controller for calculating the time, wherein the controller is in communication with the temperature sensing device and the output device; and a power source for supplying power to the controller and the output device.

A third aspect of the invention provides a liquid vessel, comprising: a hollow interior for holding the liquid; a temperature sensing device for sensing a temperature of the liquid; an input device for selecting a temperature range; an output device for communicating a time to a user; a controller for calculating the time based on the temperature and the temperature range, wherein the controller is in communication with the temperature sensing device, the input device and the output device; a power source for supplying power to the controller and the output device; and a switch for controlling the supply of power from the power source.

The exemplary aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 is an isometric representation of a liquid vessel in accordance with the principles relating to the present invention possessing both aural and visual means of indicating the time remaining when the liquid temperature reaches a specified temperature range or falls out of or rises to within a specified temperature range within the same;

FIG. 2 is an isometric representation of a liquid vessel in accordance with the principles relating to the present invention possessing visual means of indicating the time remaining when the liquid temperature reaches a specified temperature range or falls out of or rises to within a specified temperature range within the same;

FIG. 3 is an isometric representation of a liquid vessel in accordance with the principles relating to the present invention possessing aural means of indicating the time remaining when the liquid temperature reaches a specified temperature range or falls out of or rises to within a specified temperature range within the same;

FIG. 4 is a schematic representation of the sensing, logic control and time indication circuitry of a basic embodiment of the principles relating to the present invention;

FIG. 5 is a schematic representation of the sensing, logic control and time indication circuitry of a basic embodiment of the principles relating to the present invention yielding an aural indication of the time remaining;

FIG. 6 is a schematic representation of the sensing, logic control and time indication circuitry of a basic embodiment of the principles relating to the present invention yielding a simulated voice indicating the time remaining;

FIG. 7 is a schematic representation of the sensing, logic control and time indication circuitry of a basic embodiment of the principles relating to the present invention yielding a visual indication of the time remaining;

FIG. 8 is a schematic representation of the sensing, logic control and time indication circuitry of a basic embodiment of the principles relating to the present invention yielding a LED graphic display of the time remaining in minutes; and

FIG. 9 is a schematic representation of the sensing, logic control and time indication circuitry of a basic embodiment of the principles relating to the present invention yielding a LCD graphic display of the time remaining in minutes.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Throughout this discussion, the term ‘liquid vessel’ is used to generically refer to any open or closed vessel that is adapted to hold liquid (e.g., mug, thermos, decanter, etc.). The term can also include vessels having thermally insulated walls, covers, and/or bases to help isolate the liquid from the surrounding environment. Further, the term is inclusive of vessels having one or more handles for assisting an individual in gripping and holding the vessel. The term includes, for example, open mouth vessels from which an individual can drink a beverage, including a mug and/or a cup, and other vessels for storing and dispensing liquids, including, for example, a liquid dispenser, pitcher, thermos, decanter, and container. Further, the term ‘temperature range’ is used throughout the discussion and encompasses both a contiguous range of temperatures as well as a single temperature.

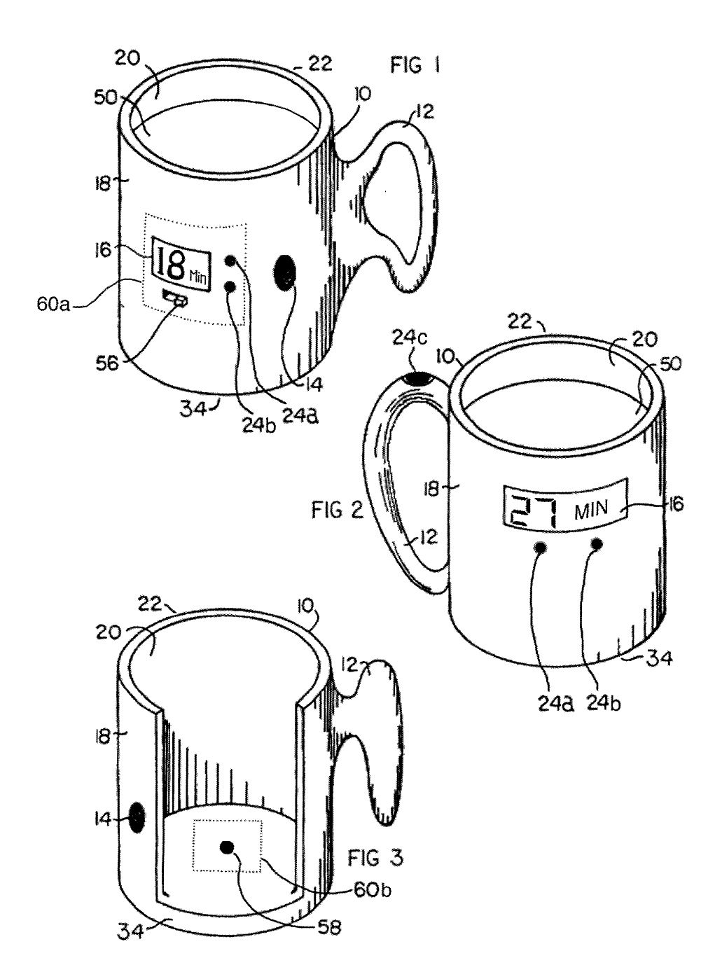

FIG. 1 depicts a liquid vessel 10 having a handle 12, both aural means 14 and visual means 16 of indicating time remaining before a liquid 50 temperature reaches a specified temperature range and/or goes out of a specified temperature range. FIG. 2 depicts a similar liquid vessel 10 possessing only visual means 16 of indicating the time remaining before the liquid 50 temperature reaches a specified temperature range and/or goes out of a specified temperature range. FIG. 3 depicts another similar liquid vessel 10 possessing only aural means 14 of indicating the time remaining. Each liquid vessel 10 depicted in FIGS. 1, 2, and 3 includes aural means 14 and/or visual means 16 of indicating time incorporated within the exterior surface 18 of liquid vessel 10. Each liquid vessel 10 further includes an interior surface 20 which is closed at the bottom 34 and open at the top 22.

As shown in FIG. 1, circuitry 60a can be located between interior surface 20 and exterior surface 18 of liquid vessel 10. Alternatively, as shown in FIG. 3, circuitry 60b can be located within bottom 34. Other locations of the circuitry of the current invention are possible, including, for example, handle 12. The location of circuitry 60a-b can be selected to easily implement communications with the various I/O devices used in the current invention. Additionally, the location of circuitry 60a-b can be selected so that it does not adversely affect use of liquid vessel 10 or adversely affect the appearance of liquid vessel 10.

Circuitry 60a-b includes the necessary components for controlling operation of the various I/O devices implementing the current invention. For example, a computer program product can be stored in a memory and execute on a CPU to implement the desired functionality. Alternatively, the functionality can be implemented by using hardware specifically configured to implement the desired functions.

As shown in FIG. 3, thermistor 58 can be located within bottom 34 for sensing a temperature of liquid 50. This allows thermistor 58 to obtain a temperature reading from within liquid 50 even when only a small amount of liquid 50 is present. Alternatively, thermistor 58 can be located along interior surface 20. Additionally, a plurality of thermistors 58 can be used and averaged to obtain a more accurate temperature of liquid 50. One or more thermistors 58 can also be placed, for example, on exterior surface 18 to sense a temperature of the environment.

Liquid vessel 10, as depicted in FIG. 1, can further include two manual switches 24a and 24b. Switches 24a-b can control the supply of power to electronic components contained by liquid vessel 10. In addition, they may be variously used to manipulate an interactive program in an integrated circuit (IC) logic controller to input a preferred temperature range. Furthermore, switches 24a-b may be used to cycle through and change other user interface preferences and options such as selecting the temperature scale, i.e., Celsius, Fahrenheit or Kelvin. The manual switches 24a-b as depicted in FIG. 1, may be employed to control power to certain electronic components, such as the visual display 16, while the switch 24c incorporated into the handle 12, such as that depicted in FIG. 2, might activate other electronic components.

A user can program a temperature range using switches 24a-c. For example, switch 24c can be used to toggle what is shown on display 16. Display 16 can show a low and/or high temperature value for the temperature range. Switches 24a-b can be used to increase/decrease the low/high temperature values. Once the desired temperatures are selected, switch 24c can be used to toggle display 16 to show a particular time that is calculated using the temperature of a liquid that is sensed and the temperature range that was input. If liquid 50 is not within the temperature range, then display 16 can show an estimated amount of time before liquid 50 reaches the temperature range. However, if liquid 50 is within the temperature range, display 16 can show an estimated amount of time before liquid 50 goes out of the temperature range.

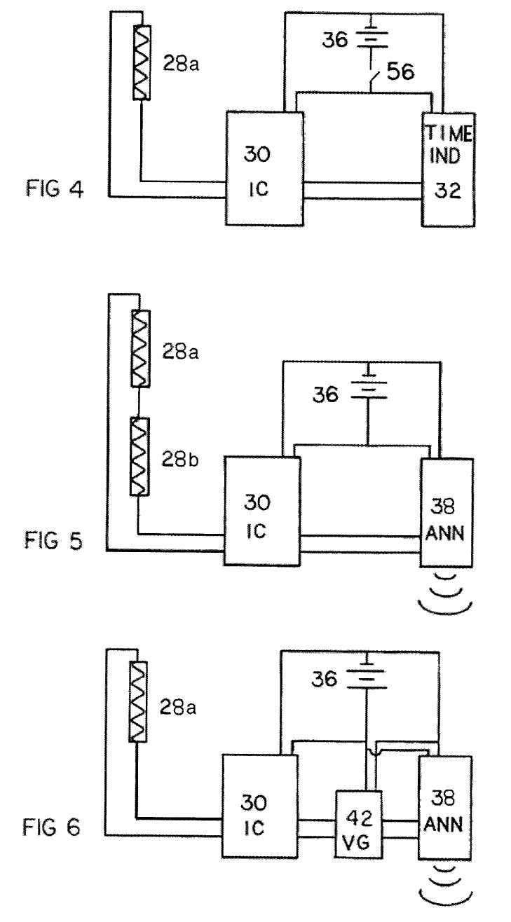

FIG. 4 depicts the electronic components of a basic embodiment of the principles relating to the present invention wherein a thermistor 28a is electrically connected to an integrated circuit (IC) logic controller 30 as an input. IC controller 30 is further electrically connected to an output device 32 (e.g., liquid crystal display (LCD)), sending it an appropriate signal for indication of the time calculated by the IC controller 30 using the thermistor 28a as an input.

IC controller 30 can include a memory for storing and retrieving data. For example, IC controller 30 can store temperature readings obtained from thermistor 28a during operation. All temperature readings can be stored, or selected periodic temperature readings (i.e., every minute, hour, etc.) can be stored and later retrieved. The stored readings can subsequently be used to adjust equations based on the actual data readings, plot the temperature readings over time, etc. Additionally, personalized settings such as a preferred temperature range can be stored and recalled in the memory for subsequent uses.

Thermistor 28a can be disposed proximate the interior surface 20 of liquid vessel 10 towards the bottom 34, for accurate temperature reading of liquid 50. Additionally, thermistor 28a can read an ambient temperature before liquid 50 is placed within liquid vessel 10. A battery 36, thermistor 28a, IC controller 30 and all wiring connections can be contained within liquid vessel 10.

Other sensing devices and/or inputs may also be used with the invention. For example, FIG. 5 depicts two thermistors 28a-b. Thermistor 28a can be used to measure a temperature of liquid 50 within liquid vessel 10, while thermistor 28b can be used to measure the ambient temperature during operation. This allows the time approximation to continually compensate for a changing environment. Additionally, a cover sensing device can be used to detect the presence/absence of a cover, a volume sensing device can be used to sense the presence and/or volume of liquid, etc. Each of these measurements can then be used to provide an improved time estimation.

FIG. 5 also depicts an exemplary use of aural means 14 for indicating the time calculated by IC controller 30 comprising a simple annunciator 38 electrically connected to IC controller 30 and battery 36 such that the signal from IC controller 30 effects the generation of sound waves by annunciator 38 modulated by IC controller 30 in accordance with the time calculated by IC controller 30 using thermistors 28a-b as an input. It is considered that the sound produced may be modulated in any fashion to render comprehensible an accurate indication of the time calculated by IC controller 30 using thermistors 28a-b as an input.

FIG. 6 depicts a schematic similar to the embodiment of the principles related to the present invention discussed above utilizing an annunciator 38 to which a simulated voice generator 42 is additionally connected electrically to both the annunciator 38 as an input device and to the IC controller 30 as an output device and further connected to the battery 36. The ability to have the time, calculated by the IC controller 30 using thermistor 28a as an input, spoken in minutes by the annunciator 38 connected to a simulated voice generator 42 is considered to comprise a preferred aural means 14 of time remaining indication.

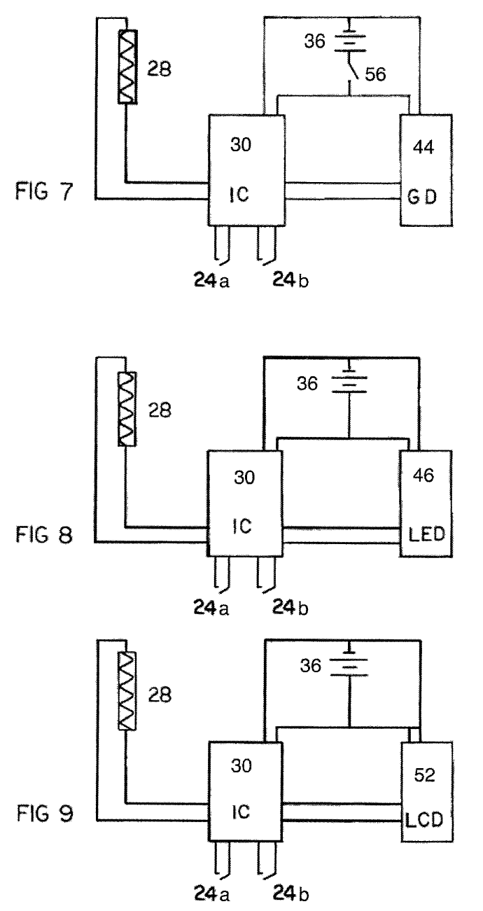

As opposed to aural means 14 of time indication, FIGS. 7, 8, and 9 are concerned with the visual means 16 of time indications as illustrated in FIGS. 1 and 2. FIG. 7 depicts an embodiment of the principles relating to the present invention utilizing a thermistor 28 connected as input to an IC controller 30 as discussed above, having as an output device a graphic display 44. It is primarily intended in this alternate embodiment that the time calculated by IC controller 30 using thermistor 28 as an input, be expressed in minutes, graphically, as opposed to by a simulated voice as discussed earlier. Otherwise, it is considered that the two principal types of screens readily permitting graphic display of a time in minutes are light emitting diodes (LED) 46 represented in FIG. 8 and liquid crystal display (LCD) 52 represented in FIG. 9 comprise specific types of the generic graphic display 44 represented in FIG. 7. The schematics represented in FIGS. 4-9 have IC logic controller 30 and output device 32, or the annunciator 38 and, perhaps, voice generator 42 as all being directly wired to a battery 36. Thermistor 28 has current through it but this current acts as a signal read by the IC logic controller 30 and is considered to be supplied by the power supplied to the same.

Another consideration concerns switching of the power to the electronic components, including the means of time indication 32. FIG. 7 represents an embodiment of the principles relating to the present invention utilizing a generic switch 56 as controlling the power supplied from battery 36 to all the electronic components utilized. This switch 56 is understood to represent the use of any type, including the explicitly manual switch 56 as represented in FIG. 1. Switches 24a-c incorporated in the exterior 18 of liquid vessel 10 depicted in FIGS. 1 and 2 share qualities of switch 56. Switches 24a-c depicted in FIG. 2 are operated by the exertion of manual pressure. The switching so effected may be considered conscious and therefore manual, or unconscious and therefore automatic. Another embodiment of the present invention involves an automatic switching function embedded in the IC controller 30 that switches electrical power from the battery 36 to the aural 14 or visual 16 indicator automatically, based upon any switching activity from switches 24a-c. This embodiment requires a constant supply of electricity from battery 36 to parts of IC controller 30. Another embodiment of the present invention uses switch 24a to switch power to all electrical components in liquid vessel 10 and relies on a predetermined shut-off timer function within the IC logic controller 30 to automatically shut off power to all electrical components in liquid vessel 10 after some predetermined amount of switches 24a-b inactivity. While only two switches are illustrated in the henceforth described embodiment, more or less may be equally considered.

Many other combinations of switching are recognized in the selection of components to be automatically switched to power, manually switched to power or unswitched. Furthermore, another factor to consider in which switching combination is considered preferable is the size of battery 36 with regard to power usage of the components in operation and the relative ease and cost of replacement of battery 36. Further still, it is considered that one battery 36 might be dedicated to some components and another battery 36 dedicated to others.

It is further noted that switches 24a-c and the manual switch 56 depicted in FIGS. 1 and 2 are displaceable and further comprise a portion of the exterior surface 18 of liquid vessel 10. It is considered desirable to have any switches 24a-c utilized in an embodiment of the principles relating to the present invention sealed with respect to exposure of any electrical connections. A sealed ‘push button’ type switch is therefore preferred. The manual switch 56 represented in FIG. 1 emphasizes the deliberate aspects of a ‘manual’ switch. Similarly, the manual switches 24a-c represented in FIGS. 1 and 2 emphasize the deliberate aspects of a manual ‘push button’ type switch.

It is understood that thermistor 28 varies in electrical resistance in accordance with temperature and acts as an input to IC controller 30. It is therein assumed that the IC controller contains all necessary components required to process the change in electrical resistance in the thermistor 28. There are three aspects of this which have not been fully addressed, however.

First, it is noted that the electrical resistance of a thermistor 28 does not vary linearly with respect to temperature. The actual temperature/resistance curves involved over the temperature range addressed must be known and the IC controller 30 programmed to reflect the same in order for an accurate reading of the temperature to be made using a thermistor 28.

Second, the method by which the thermistor 28 serves as a signal input to the IC controller 30 has not been detailed. There are many ways in which this may be done. The logic involved in programming the IC is considered to be well within the scope of one practiced in the art.

Third, the method by which the IC controller 30 may calculate a time value from a data input from one or more thermistors 28 has not yet been addressed. In order for the IC controller 30 to use a single data input from thermistor 28 and output an accurate time value, liquid vessel 10 must be thermally modeled in the form of a mathematical equation, taking into account various cooling or heating effects such as ambient temperature, convection rate, and some others. The resulting mathematical representation must be programmed into the IC logic controller 30. There are many different ways to do this, and some may require certain assumptions. It is considered that thermally modeling liquid vessel 10 is well within the scope of one practiced in the art. The best method, i.e. the method which leads to a simple mathematical formula, and therefore the optional use of a simple and inexpensive IC controller 30, involves making the following basic assumptions: assume a constant ambient temperature (for example, room temperature, or about 70 degrees Fahrenheit); assume constant liquid 50 density; assume a fairly constant liquid 50 volume; assume a constant convection rate of air over the open top 22; assume a uniform temperature distribution within liquid 50. With these assumptions it is possible to accurately estimate the cooling rate for a hot liquid in the form of the following equation: Cooling Rate=−(Current Temperature−Ambient Temperature)/(Cooling Constant). The Cooling Constant can be empirically derived and is dependent on the specific physical characteristics of liquid vessel 10; this is a simplistic thermal model. More complex thermal models will result in more accurate time calculations.

Other considerations regarding construction are largely obvious. Thermally insulated liquid vessels are often constructed out of plastic which is an excellent material with regard to electrical insulation of the electronic components utilized in liquid vessel 10 in accordance with the principles relating to the present invention. The output device(s) 32 have a surface comprising a portion of the exterior liquid vessel surface 18. The thermistor 28 is located to yield an accurate reflection of the hot or cold liquid 50 contained, the battery or batteries 36 are preferably accessible for replacement, but otherwise all the electronic components and any and all necessary associated with the same is preferably encased within the material of which liquid vessel 10 is constructed, bounded by a comprehensive surface which is preferably waterproof.

The manner of using liquid vessel 10 with cooling time approximation to transport, insulate and drink from is identical to that of any other cup, mug or other liquid device intended for the drinking of hot or cold liquids. Namely, one pours into liquid vessel 10, through the open top surface 22, the liquid 50 to be imbibed. When ready to drink liquid 50 in liquid vessel 10, one raises liquid vessel 10 to one's lips and drinks from it as one would drink from any cup, mug or other similar liquid container.

The electronic components of the liquid vessel with time approximation can be activated and utilized in many different ways, some of which have been previously described. The following is a description of one possible embodiment, for the case of a hot beverage imbibed using the present invention. To activate the visual means of time indication 16 once a hot beverage has been poured into liquid vessel 10, one may simply depress any of the manual switches 24a-c. Once activated, the user can use switched 24a-c to modify the target temperature range. The preferred drinking temperature range and temperature scale, as well as other programmable preferences, such as the use of the aural temperature indicator 14, may be programmed using a predetermined series of inputs from manual switches 24a-c based upon a user interface programmed into the IC logic controller 30. A previous temperature range can be stored and used by default. Multiple temperature ranges can be stored and selected using switches 24a-c to accommodate more than one drinking preference and/or hot and cold drinks.

Once any one of the manual switches 24a-c have been depressed, the display is activated and indicates the amount of time remaining until the liquid temperature will reach the user specified preferred drinking temperature range. The current temperature of liquid 50 may be temporarily displayed by depressing, for example, switch 24b. Once the liquid 50 temperature has reached the preferred drinking temperature range, the display can indicate the amount of time remaining before the liquid temperature goes out of the preferred drinking temperature range. A display backlight may be activated by depressing any of the manual switches 24a-c for a predetermined amount of time. The electronic components may automatically deactivate after a predetermined amount of inactivity, as defined by user inactivity with regard to switches 24a-c, and 56. More or less switches may be employed under similar and different embodiments of the herein described invention.

It is noted that the invention herein disclosed may also be used with a cover of some sort that would cover the open top surface 22 of liquid vessel 10 to stop liquid 50 spillage and to better thermally insulate liquid vessel 10 contents. Such a cap or covering object may include a small drinking hole or holes or other perforations to aide in drinking and/or ventilation.

Thus the reader will see that the liquid vessel with cooling/warming time approximation, the invention herein disclosed, provides a better, safer, more efficient and enjoyable warm and cold drinking experience that can be used by persons of any age, and for any liquid that is preferred at any temperature range. This invention negates the necessity for one who has just served him or herself a hot liquid to constantly divert their attention to the liquid to determine whether or not it is drinkable yet, risking sometimes sever burns or accidents and possible litigation. Similarly, this invention allows for more efficient and safer liquid replenishment management for restaurants who serve heated, as in the case of coffee, or cooled, as in the case of dairy products, liquids out of unmonitored insulated liquid dispensers in warn ambient environments, such as room temperature.

The invention herein disclosed provides an accurate indication of the time remaining until the temperature of liquid 50 contained reaches a specified temperature range and/or goes out of a temperature range that is user specified, from it's initial serving temperature. This specified temperature range may be known as the ‘preferred temperature range.’

While the above description contains many specifics, these should not be construed as limitations on the scope of the invention, but rather as an exemplification of one preferred embodiment thereof. Many other variations are possible. For example, it is noted that this same liquid vessel 10 as herein described may be used specifically in medical care environments, such as hospitals, for the delivery of those medications and other health care substances that require the delivery of the substances at a specified temperature range. Furthermore, it is noted that the functions of the electronics herein described, specifically that of the visual 16 and/or aural 14 means of indication of the time remaining until the liquid 50 temperature reaches a specified temperature range and/or goes out of a specified temperature range, may be used and applied to larger thermally insulated liquid containers, such as those used in restaurants and cafés for the use of serving either hot or cold liquids such as coffee, tea, milk or other such liquids. It is noted that this invention may be used specifically in the case of milk or other dairy liquids to indicate the amount of time remaining before the dairy liquid is likely to spoil in warm ambient environments. Another possible embodiment of the present invention includes the use of the invention herein disclosed in large scale hot and cold insulated liquid dispensers, pitchers, and containers, such as those used for dispensing dairy based or other liquids. Furthermore, the invention herein disclosed may be used in medical and/or healthcare environments for the use of directly monitoring those medications and other such substances that require delivery or use at a specific temperature range. Additionally, the invention herein disclosed may be used in other environments where it is desirable to know how much time remains before a liquid cools to a specific temperature range and/or goes out of a specified temperature range. Similarly, the invention herein disclosed may be used in environments where it is desirable to know how much time remains before a liquid heats to a specific temperature range, or how much time remains before a liquid rises into a specific temperature range for the cases that the liquid temperature is below ambient temperature.

The invention can be further applied to more general containers for storing hot and/or cold items. The containers can be covered or not covered, and insulated or non-insulated. For example, the invention can provide the time remaining that the cold/frozen foods, beverages, etc. placed in an insulated, covered cooler will remain in a desired temperature range. Alternatively, the invention can be used on an open, non-insulated container to provide time estimates for the amount of time before a hot dish cools to a desired temperature and the amount of time that the hot dish will remain in a desired temperature range.

Accordingly, the scope of the invention should be determined not by the embodiments illustrated, but by the appended claims and their legal equivalents.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A liquid vessel, comprising:
a hollow interior for holding liquid;
a temperature sensing device for sensing a temperature of the liquid; and
an output device for communicating a time to a user based on the temperature.

2. The vessel of claim 1, further comprising:
an open end for accepting the liquid; and
a cover for the open end, wherein the cover encloses a majority of the hollow interior.

3. The vessel of claim 1, wherein the temperature sensing device comprises a thermistor.

4. The vessel of claim 1, further comprising a handle for holding the vessel.

5. The vessel of claim 1, further comprising a power source for the output device.

6. The vessel of claim 5, further comprising a switch for controlling the supply of power from the power source.

7. The vessel of claim 1, further comprising a controller for calculating the time, wherein the controller is in communication with the temperature sensing device and the output device.

8. The vessel of claim 1, further comprising an input device for selecting a temperature range, wherein the time is further based on the temperature range.

9. The vessel of claim 1, wherein the time comprises an estimated amount of time before the liquid reaches a temperature range.

10. The vessel of claim 1, wherein the time comprises an estimated amount of time that the liquid will remain in a temperature range.

11. The vessel of claim 1, wherein the output device comprises one of the group consisting of: an annunciator and a display.

12. A liquid vessel, comprising:
a hollow interior for holding liquid;
a temperature sensing device for sensing a temperature of the liquid;
an output device for communicating a time based on the temperature to a user;
a controller for calculating the time, wherein the controller is in communication with the temperature sensing device and the output device; and
a power source for supplying power to the controller and the output device.

13. The vessel of claim 12, further comprising a switch for controlling the supply of power from the power source.

14. The vessel of claim 12, further comprising a second temperature sensing device for sensing an ambient temperature, wherein the time is further based on the ambient temperature.

15. The vessel of claim 12, further comprising a volume sensing device for sensing a volume of liquid, wherein the time is further based on the volume.

16. A liquid vessel, comprising:
a hollow interior for holding the liquid;
a temperature sensing device for sensing a temperature of the liquid;
an input device for selecting a temperature range;
an output device for communicating a time to a user;
a controller for calculating the time based on the temperature and the temperature range, wherein the controller is in communication with the temperature sensing device, the input device and the output device;
a power source for supplying power to the controller and the output device; and
a switch for controlling the supply of power from the power source.

17. The vessel of claim 16, further comprising a second temperature sensing device for sensing an ambient temperature, wherein the time is further based on the ambient temperature.

18. The vessel of claim 16, further comprising a volume sensing device for sensing a volume of liquid, wherein the time is further based on the volume.

19. The vessel of claim 16, further comprising:
an open end for accepting the liquid; and
a cover for the open end, wherein the cover encloses a majority of the hollow interior.

20. The vessel of claim 19, further comprising a cover sensing device for sensing the presence of the cover, wherein the time is further based on the presence of the cover.
